(19) United States
(12) Patent Application Publication
(10) Pub. No.: US 2008/0066949 A1
(43) Pub. Date: Mar. 20, 2008

(54) Sealing grommet

(75) Inventor: Randy G. Cloud, Mentor, OH (US)

Correspondence Address: FAY SHARPE LLP, 1100 SUPERIOR AVENUE, SEVENTH FLOOR, CLEVELAND, OH, 44114, US

(73) Assignee: Preformed Line Products Company

(21) Appl. No.: 11/522,877

(22) Filed: Sep. 15, 2006

(51) Int. Cl. H01B 17/26

(52) U.S. Cl. 174/153 G

(57) ABSTRACT

The present disclosure describes a grommet for sealing an opening in a two piece enclosure and formed with a sealing passageway for engaging a member to be supported by the grommet. The grommet comprises an outer peripheral ring section and an inner ring section. The inner ring section comprises a material having a durometer hardness reading and including a central section adapted for receiving a fiber optic cable therethrough. The outer peripheral ring section comprises a material having a relatively harder durometer hardness reading which is adapted to be sealingly mounted in an irregular opening defined between, for example, an end plate and a bulkhead of a fiber optic enclosure.

### BACKGROUND

The present disclosure relates to a sealing member or grommet. The sealing member of the present disclosure is particularly useful in a network interface device in which a single, or plurality of, fiber optic cable(s), encased in a protective liner or cover, enters an enclosure.

Historically grommets useful in network interface devices have been fabricated from a homogeneous, flexible rubber-like material. Such grommets typically include a center section in the form of a single membrane through which one or more wires, cables or conduits and the like, referred to herein as “wires”, enter or exit the device, and a thicker outer peripheral section which may be attached to an apertured surface of the device in the usual manner. In order to insert such wires into the device, typically the membrane is punctured or slit. For example, in some prior art grommets, the thin membrane which forms the center section is punctured to provide a hole through which the wires may be inserted or threaded directly through the grommet and into the device. In other prior art grommets, it is desirable to slit the grommet from the center of the membrane completely through the generally thicker outer peripheral section thereby permitting the wires to be dropped into the grommet in a generally radial direction as opposed to threaded through a hole in the grommet center.

In order to facilitate and direct the tearing or otherwise opening of the grommet material, it is common for the center section to be thin relative to the outer peripheral section. It is also common to provide the center section with a pre-creased pattern. When the term “pre-creased pattern” is used herein it is meant that the membrane has been provided with means to facilitate and direct the tearing or otherwise opening of the membrane in the desired pattern. For example, the membrane surface may be provided with thinner sections which coincide with a desired pattern. In another example, the membrane surface may be scored by providing lines, grooves, notches and the like which outline the desired pattern. In yet another example, the membrane may be provided with apertures or slits which define the desired pattern.

Some patterns are known to be preferable over others depending upon the application. Patterns in the form of thin circular areas are typical in applications where a single wire is to be pushed through the grommet. When a plurality of wires having varying sizes are to be inserted into the device, a star shaped pattern can be used. It is common for the pattern to be the same on one or both surfaces of the membrane thus providing grommets for a specific end use.

Typically the center section of prior art grommets is thin in order to facilitate the puncturing, slitting or tearing thereof as described above, and also so that the membrane will be compliant. In theory, the punctured membrane acts as a sphincter around a single wire, conduit or cable passing through the membrane to provide a tight fit to prevent moisture, dust or insects from entering the enclosure. However, durability and sealing ability are compromised when thin center sections are used. Additionally, in many enclosures such as, for example, typical network interface devices, a plurality of wires pass through the grommet. The result is that open air spaces exist around the wires due to the inability of the grommet to conform exactly to the irregular shape which is present. In addition, prior art grommets lack the ability to conform exactly to the irregular shape of the apertured surface of the enclosure device.

In other applications, sealing tape is wrapped around a center section of a grommet in successive layers in order to ‘build-up’ the outer perimeter or circumference. The successive outer tape layers provide a stiffer section in which to secure the grommet to an apertured surface of the enclosure device, for example between an end plate and a bulkhead opening. The successive wrapping of tape layers is time consuming and cumbersome for a field technician to accomplish while connecting, for example, fiber optic cables to an interface device.

### SUMMARY

The grommet of the present disclosure provides for a so-called “dual durometer” self-sealing grommet including an inner or central grommet portion which flexibly mounts a member engaging sealing passageway for generally universal tilting movement while inhibiting radial and axial movements. To be described in more detail hereinafter, the central grommet portion allows complete flexibility in alignment of the wire or cable or other member to facilitate assembly and to resist axial and radial movement after grommet installation.

The present disclosure provides for a grommet for sealing an opening. The grommet comprises an outer peripheral ring section having an outer diameter and an inner ring section having an outer diameter. The inner ring section can be matingly engaged within the outer ring section. The inner ring section includes a material having a first durometer hardness reading and defines a central section adapted for receiving a member to be sealingly supported therethrough. The outer peripheral ring section includes a material having a second durometer hardness reading and an outer perimeter adapted to be sealingly mounted in an irregular opening of an enclosure. The central section includes at least one passageway defining an aperture extending through the inner ring section. The passageway is deformable and responsive to radial forces transmitted to the passageway through the outer ring and the inner ring of the grommet when the grommet is in the mounted position.

The present disclosure provides a grommet for sealing an opening. The grommet comprises an inner ring having a continuous circumferential and axially extending first surface thereon and an opening-filling central portion containing a passageway. The inner ring being a resilient elastomeric material for sealingly engaging a cable to be supported therethrough. The grommet further provides an outer ring having a continuous circumferential and axially extending second surface having a circumferential dimension larger than said opening. The outer ring can be integrally molded to the inner ring including a harder material than the inner ring. When the grommet is installed in the opening of an enclosure, the outer ring sealing engages the enclosure and the circumferentially extending second sealing surface forms a complete seal continuously around the entire inner periphery of the opening of the enclosure. A ratio of the outer ring durometer hardness reading and the inner ring durometer hardness reading can be in the range of 1.2 to 14.0/1.0 respectively.

The present disclosure provides a grommet for sealing an opening in a two piece enclosure and formed with a sealing passageway for engaging a member to be supported by the grommet. The grommet comprises an inner ring having a continuous circumferential and axially extending first surface thereon and an opening-filling central portion containing a passageway. The inner ring includes a resilient elastomeric material for sealingly engaging a cable to be supported therethrough. The grommet further provides for an outer ring having a continuous circumferential and axially extending second surface having a circumferential dimension larger than said opening. The outer ring can be integrally molded to the inner ring and comprises a harder material than the inner ring. When the grommet is installed in the opening of an enclosure, the outer ring sealing engages the enclosure and the circumferentially extending second sealing surface forms a complete seal continuously around the entire inner periphery of the opening of the enclosure. The inner ring includes a thickness and the outer ring includes a thickness. The thickness of the outer ring is substantially equal to the thickness of the inner ring and the thickness of the outer ring is at least three times a diameter of the passageway whereby the inner ring resists axial and rotational movements of the cable within the passageway after the grommet is secured in the opening.

### BRIEF DESCRIPTION OF THE DRAWINGS

The invention may be clearly understood by reference to the attached drawings in which:

FIG. 1 is a front plan view of a first embodiment of the grommet;

FIG. 2 is a cross section view of the first embodiment depicted in FIG. 1;

FIG. 3 is a front plan view of the first embodiment of the grommet shown mounted in a fiber optic enclosure device;

FIG. 4 is a side plan view of a second embodiment of the grommet according to the disclosure;

FIG. 5 is a side plan view of a third embodiment of the grommet according to the disclosure;

FIG. 6 is a front plan view of the first embodiment of the grommet with a cable passing therethrough;

FIG. 7 is a front plan view of a fourth embodiment of the grommet;

FIG. 8 is a front plan view of a fifth embodiment of the grommet; and,

FIG. 9 is a cross section view of the fifth embodiment depicted in FIG. 8.

### DETAILED DESCRIPTION

Referring to FIGS. 1-3, wherein a first embodiment of a grommet 10 is depicted comprising an outer peripheral section or outer ring 12 and a central section or inner ring 14. The outer peripheral section 12 includes an outer circumferential surface 13 for sealing the grommet 10, for example, within an opening defined between an end plate 15 and a bulkhead 17 of a fiber optic enclosure. Outer ring 12 can include a continuous circumferential and axially extending sealing surface 13, as shown in FIG. 1. Sealing surface 13 can be made of the same harder or more rigid material as the harder portion of grommet 10. This feature provides for better wear of the grommet 10 in normal use as the harder sealing surface 13 will be more resistant to abrasion caused by frictional contact with the engaging surfaces of, for example, the end plate 15 and bulkhead 17 of the fiber optic enclosure. Grommet 10 may be formed from any known flexible grommet material such as the homogenous, flexible rubber-like materials presently used in the art. The outer peripheral section 12 can be generally the same thickness as the inner ring 14. The inner ring 14, in one version, defines a central opening, section, or passageway 16. The inner ring 14, in another version, can include piercable membrane selectively closing the inner ring 14 and sealing its central opening (not shown).

FIG. 3 shows the grommet 10, including the central opening 16 forming an opening or passageway for insertion of a member 20, i.e. cable or wire, to be held in the grommet. An interior surface 22 of the inner ring 14 provides for frictional and sealing engagement with member 20. In the installed position, grommet 10 provides a resistant force to member 20 in axial and radial directions as indicated by arrows 30 and 32, and a relatively less resistant force in universal tilting directions as indicated by arrows 34 and 36. It is to be appreciated, once the grommet 10 is installed, the member 20, including a fiber optic wire 21 therein, will be securely retained and resistant to axial and radial movements while allowing universal tilting to provide for certain variability in mounting angles. The inner ring 14 can maintain sealing engagement of the wire 20 whether in a tilted orientation or aligned orientation relative to an axis 38 through the central opening 16.

Flexibility of the inner ring 14, and the associated interior surface 22 of the grommet, can be invaluable in situations where it is difficult or impossible to align member 20 at an angle perpendicular to the bulkhead member 17. Likewise, the opening 16 permits axial movement of member 20 to aid in initial positioning during installation of the grommet. This axial movement can be to a considerable extent. After installation the ease of axial and radial movement is significantly reduced.

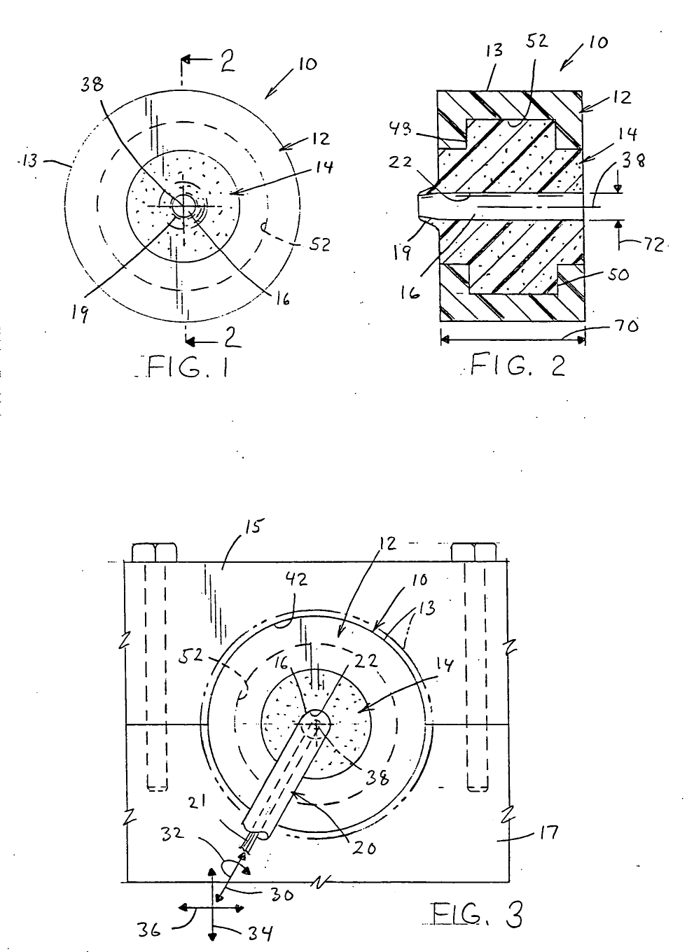

As shown in FIGS. 2 and 3, one embodiment of the present disclosure provides that the softer material of the inner ring 14 extends axially into interior portion of a relatively harder outer ring 12. In this manner, first and second shoulders 48, 50 are presented into an interior cutout 52 of outer ring 12. Cutout 52 is an example of a profile. Other profiles are contemplated, i.e. rounded edges, serrated edges, etc. This provides rigidity to the inner and outer rings 14, 12. In addition, the inner ring 14 resists decoupling from, and shearing away from, the outer ring 12 when the member 20 is moved axially in direction 30 and/or radially in direction 32 (refer to FIG. 3).

While grommet 10 is shown as being cylindrical or circular to be inserted in a circular hole or aperture, it will be appreciated that other configurations of the sealing perimeter such as a rectangular shape can be accommodated.

In an alternative configuration, the grommet can include a slit extending from the outside surface to the opening (not shown), wherein one or more wires may be dropped into the grommet in a generally radial direction. However, it will be understood by those skilled in the art that any of the embodiments of the present invention may be adapted such that the wires may be dropped into the grommet rather than inserted through one or more apertures in the central portion or section of the grommet.

The outer ring and the relatively softer sealing inner ring materials can be thermoplastic or thermosetting resins or mixtures thereof which can be cast as plastisols such as vinyl. The outer ring portion can be an annular ring and the central hole filling portion can be a softer vinyl body portion which can include a flexible snout 19 (see FIG. 2) having a central opening to support the wire or cable member which extends through the opening. This snout 19 can provide enough flexibility to yield or stretch and sealingly engage the member 20 and further inhibit axial and radial movements of the inserted member relative to the grommet after installation.

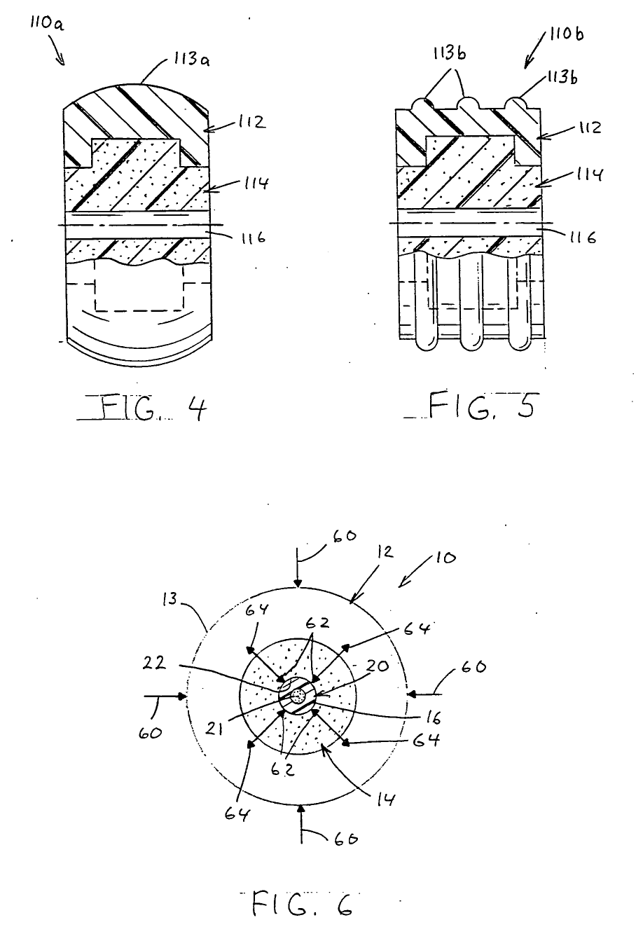

Referring now to FIGS. 4 and 5, wherein other embodiments of a grommet 110a, 110b are therein shown. It is to be appreciated that an outer sealing surface can include a bulbous flange 113a (FIG. 4), or multiple bulbous flanges 113b (FIG. 5). The flanges 113a, 113b assist with sealing the opening of the fiber optic enclosure. In particular, flanges 113a, 113b assist with sealing an uneven, rough, or less than round opening in a two piece fiber optic enclosure.

Grommet 10 can have a harder or more rigid portion in the form of outer ring 12. The largest dimension or diameter of the outer ring can be larger than the aperture 42 into which the grommet 10 is inserted thereby transmitting axial forces inward around the entire grommet after installation. Referring now to FIG. 6 wherein it is to be appreciated that in a mounted position, tightening the end plate around the outer ring results in compressive forces 60 being transmitted radially to the inner ring 14. The inner ring 14 in turn communicates compressive forces 62 around member 20. Counter axial forces 64, resulting from insertion of member 20, extend from the inner surface of the inner ring 14 outward. The relatively soft materials in the inner and outer rings 14, 12 enable the opposing forces to be dissipated and equalized within the rings while providing retention forces on member 20 and sealing of the outer surface 13 of the outer ring 12 within, for example, the end plate 15 and bulkhead 17. The aforementioned properties provides for a self-adjusting and self-sealing grommet 10 designed to adjust to different sized cables and wires passing therethrough, and to adjust for different sized openings mounted therein. Once installed, the resilient and ‘spring-like’ inner and outer rings 14, 12 not only retain the grommet firmly in place but also provide for a dust and water resistant seal around the outer surface of the grommet and around the cable passing through the inner opening.

The inner and outer rings can have substantially the same thickness 70 to facilitate retention of member 20 and to facilitate dust and water resistance. The ratio of thickness 70 of grommet 10 to the inside diameter 72 of the inner ring 14 can be in the range of at least two to one. One particular application includes a ratio of at least four to one. The relatively soft material of the inner ring, along with the thickness of the inner ring, provides frictional gripping forces to hold and seal a member therein after installation of the grommet in an enclosure device. The relatively large surface area of the cable in contact with the interior surface of the inner ring can be calculated as: [pi×(diameter 72)×(thickness 70)]. It is to be appreciated that the resiliency of the inner ring enables a wide range of cable sizes to pass through the passageway. In one application, a diameter 72 of 0.250 inches was used to accommodate and seal around a member 20 ranging in diameter between 0.125 inches and 0.500 inches. Similar ratios can be achieved for various sized members (regular and irregular) and associated diameters, for example, members ranging in diameter from one fourth to two times the diameter of the opening 16. After installation, member 20 can be universally tilted (not shown) without disturbing its dust and water resistance. Grommet 10 thereby allows and accommodates minimum bending radii of fiber optic cables, while at the same time resisting axial and radial movements of same said fiber optic cables resulting from the frictional forces between the surface area of the cable and the interior surface of the inner ring.

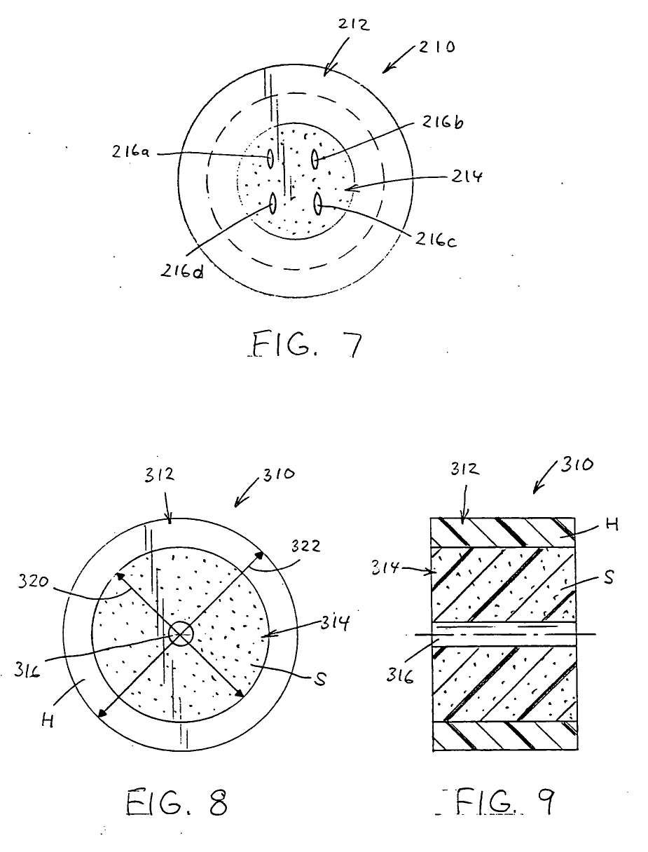

The combination of the inner ring and outer ring, along with their relative hardnesses, enables mounting in a range of openings in the engaging surface, as well as a range of fiber optic cables to be mounted through the center of the inner ring. In this manner, a limited number of the grommets can be carried by the field technician and each grommet used as a ‘universal’ grommet for a multitude of installations having varying dimensional requirements. The present disclosure provides an improved grommet having a central section which will conform to and seal around one or more wires, having varying diameters, which pass through the grommet. Referring to FIG. 7, there is illustrated another embodiment of a grommet 210 including multiple openings 216a, 216b, 216c, 216d, within an inner ring 214. Any number of openings can be arranged within inner ring 214. It is to be appreciated that a relatively harder outer ring 212 surrounds inner ring 214.

Referring now to FIGS. 8 and 9 wherein still another embodiment of a grommet 310 is therein shown. It is to be appreciated that a two stage injection molding process or method of manufacturing the grommet 310 can be employed. At the first injection molding station the harder or more rigid material portion, i.e. outer ring 312, of the grommet can be injection molded. The harder molded material H, along with one of the mold halves, can then be transferred to a second injection molding station where the softer material S can be injection molded to bond with the harder material H. The softer material S includes all of the inner ring 314 components. When the second injection molding step is complete, the grommet is ejected from the mold and the transferred mold half can be returned from second molding station to first molding station to repeat the process.

Alternatively, rings 312, 314 may be thermally bonded or otherwise joined by commingling of cavities. For example, such mating engagement may be provided by fabricating the grommet in a dual durometer molding process using a rigid material to form configuration 312 and a less rigid material to form configuration 314. If desired, such mating may be provided by a male segment and female segment of a typical T-shaped connection. The outer portion 312 may be a rigid or semi-rigid material such as any of a variety of thermoplastic and thermoset resins and the central portion 314 may be a soft and flexible gum-my material such as a thermoplastic elastomer.

As mentioned earlier, a variety of thermoplastic or thermosetting resilient plastics can be used for the harder and softer materials. In order to facilitate the sealing engagement in installation and retention, the harder material H, for the outer ring 12, 112, 212, 312 can have a durometer hardness in the range of 30 to 70 Shore A. The specific hardness of the outer ring is dependent upon the specifications of the grommet. Durometer hardnesses between 40 Shore A and 60 Shore A for the outer ring element have been used for different applications. The relatively softer material, for the inner ring 14, 114, 214, 314 can have a durometer hardness in the range of 5 to 40 Shore A. The specific hardness of the inner ring is dependent upon the specifications of the grommet. Durometer hardnesses between 10 Shore A and 30 Shore A for the inner ring element have been used for different applications. The ratio of hardness of the outer ring to the inner ring can be in the range of 1.2 to 1.0 and 14.0 to 1.0, respectively.

Additionally, the outer diameters of the inner and outer rings affect the resiliency of the grommet and the sealing of an opening, i.e. opening 316. In one example, the outer diameter of the inner ring can be at least one half the outer diameter of the outer ring (see for example FIG. 6). In another example, the outer diameter 320 of the inner ring 314 can be at least three fourths the outer diameter 322 of the outer ring 312 (FIG. 8). The latter example results in a relatively slower recovery of the grommet back to its original shape after compression, while providing for increased sealability of the central opening(s). This accommodates a variety of cables and can ensure that there is a tight seal even where the cable itself has imperfections on the surface. It is to be appreciated that the latter example includes a larger volume of a relatively softer material relative to the total volume of the grommet.

A thermoplastic polypropylene resin can be formulated for both the harder and softer components of the grommet. It is to be appreciated that the material for the inner and outer rings can be selected from other materials including, for example, polypropylene, rubber, urethane, and silicone. Fiberglass may be added to enhance the strength and rigidity of the material. Mica may be added to enhance rigidity to a greater extent but would have the added effect of reducing tensile and shear strength.

From the foregoing detailed description, it will be evident that there are a number of changes, adaptations and modifications of the present invention which come within the province of those persons having ordinary skill in the art to which the aforementioned invention pertains. However, it is intended that all such variations not departing from the spirit of the invention be considered as within the scope thereof as limited solely by the appended claims.

We claim:

1. A grommet for sealing an opening comprising:
an outer peripheral ring section having an outer diameter;
an inner ring section having an outer diameter;
said inner ring section matingly engaged within said outer ring section;
said inner ring section comprising a material having a first durometer hardness reading and defining a central section adapted for receiving a member to be sealingly supported therethrough;
said outer peripheral ring section comprising a material having a second durometer hardness reading and an outer perimeter adapted to be sealingly mounted in an irregular opening of an enclosure;
said central section including at least one passageway defining an aperture extending through said inner ring section; and,
said passageway is deformable and responsive to radial forces transmitted to said passageway through said outer ring and said inner ring of said grommet when said grommet is in the mounted position.

2. The grommet according to claim 1, wherein said at least one passageway comprises a piercable membrane.

3. The grommet according to claim 1, wherein said first hardness of said inner ring section is less than said second hardness of said outer ring section.

4. The grommet according to claim 1, wherein said outer diameter of said inner ring is at least one half of said outer diameter of said outer ring.

5. The grommet according to claim 3, wherein said hardness of said inner ring section is in the range of 5 to 40 Shore A and said hardness of said outer ring section is in the range of 30 to 70 Shore A.

6. The grommet according to claim 1, wherein said outer diameter of said inner ring is at least three fourths of said outer diameter of said outer ring.

7. The grommet according to claim 1, wherein said central section including at least another passageway defining another aperture extending through said inner ring section.

8. The grommet assembly according to claim 1, wherein said inner ring includes a thickness; and,
said thickness of said inner ring is at least three times a diameter of said at least one passageway whereby said inner ring resists axial and rotational movements of said cable within said at least one passageway after said grommet is secured in said opening.

9. The grommet assembly according to claim 1, wherein said outer perimeter comprising a bulbous flange therearound.

10. A grommet for sealing an opening comprising:
an inner ring having a continuous circumferential and axially extending first surface thereon and an opening-filling central portion containing a passageway, said inner ring being a resilient elastomeric material for sealingly engaging a cable to be supported therethrough;
an outer ring having a continuous circumferential and axially extending second surface having a circumferential dimension larger than said opening;
said outer ring integrally molded to said inner ring and comprising a harder material than said inner ring;
wherein when said grommet is installed in said opening of an enclosure, the outer ring sealing engages said enclosure, said circumferentially extending second sealing surface forming a complete seal continuously around the entire inner periphery of said opening of said enclosure; and,
a ratio of said outer ring durometer hardness reading and said inner ring durometer hardness reading is between 1.2 and 14.0 to 1.0.

11. The grommet assembly according to claim 10, wherein the material forming said inner ring has a durometer hardness reading in the range of 5 to 40 Shore A and the material forming said outer ring has a durometer hardness in the range of 30 to 70 Shore A.

12. The grommet assembly according to claim 11, wherein the material forming said inner and said outer ring includes a majority of the same material.

13. The grommet assembly according to claim 12, wherein the material is selected from the group consisting of thermoplastic, polypropylene, urethane, and silicone.

14. The grommet assembly according to claim 10, wherein said inner ring defines an inner diameter and an outer diameter and said outer ring defines an inner diameter and an outer diameter; and,
said outer diameter of said outer ring is at least two times said outer diameter of said inner ring.

15. The grommet assembly according to claim 14, wherein said outer diameter of said inner ring is at least two times said inner diameter of said inner ring; and,
said inner ring defines an axially centered central portion therethrough adapted to provide said passageway for said cable.

16. The grommet assembly according to claim 10, wherein said inner ring is integrally molded to said outer ring;
said inner ring defines an inner diameter and an outer diameter and said outer ring defines an inner diameter and an outer diameter; and,
said outer diameter of said outer ring is at least one and one third times said outer diameter of said inner ring.

17. The grommet assembly according to claim 16, wherein said outer diameter of said inner ring is at least six times said inner diameter of said inner ring; and,
said inner ring defines an axially centered portion therethrough adapted to provide said passageway for said cable.

18. The grommet assembly according to claim 16, wherein said outer ring includes a thickness; and,
said thickness of said outer ring is at least three times a diameter of said passageway.

19. The grommet assembly according to claim 18, wherein said inner ring includes a thickness; and,
said thickness of said outer ring substantially equal to said thickness of said inner ring whereby said inner ring resists axial and rotational movements of said cable within said passageway after said grommet is secured in said opening.

20. The grommet assembly according to claim 10, wherein said outer ring includes a thickness and said inner ring includes a thickness; and,
said thickness of said outer ring substantially equal to said thickness of said inner ring.

21. The grommet assembly according to claim 10, wherein said circumferential and axially extending second surface comprising a bulbous flange therearound.

22. A grommet for sealing an opening in a two piece enclosure and formed with a sealing passageway for engaging a member to be supported by the grommet comprising:
an inner ring having a continuous circumferential and axially extending first surface thereon and an opening-filling central portion containing a passageway, said inner ring being a resilient elastomeric material for sealingly engaging a cable to be supported therethrough;
an outer ring having a continuous circumferential and axially extending second surface having a circumferential dimension larger than said opening;
said outer ring integrally molded to said inner ring and comprising a harder material than said inner ring;
wherein when said grommet is installed in said opening of an enclosure, the outer ring sealing engages said enclosure, said circumferentially extending second sealing surface forming a complete seal continuously around the entire inner periphery of said opening of said enclosure;
wherein said inner ring includes a thickness and said outer ring includes a thickness; and,
said thickness of said outer ring substantially equal to said thickness of said inner ring and said thickness of said outer ring is at least three times a diameter of said passageway whereby said inner ring resists axial and rotational movements of said cable within said passageway after said grommet is secured in said opening.

23. The grommet according to claim 22, wherein said inner ring comprising a material having a first durometer hardness reading and said outer ring comprising a material having a second durometer hardness reading; and,
wherein a ratio of said outer ring durometer hardness reading and said inner ring durometer hardness reading is between 1.5 and 10.0 to 1.0.

24. The grommet according to claim 22, wherein said continuous circumferential and axially extending second surface including a bulbous flange therearound.
